(19) United States
(12) Patent Application Publication
(10) Pub. No.: US 2012/0023832 A1
(43) Pub. Date: Feb. 2, 2012

(54) SNAP-ACTING LOCKING DEVICE, PARTICULARLY FOR LIDS, DOORS AND THE LIKE

(76) Inventor: Bruno Levi, Brescia (BS) (IT)

(21) Appl. No.: 13/255,284

(22) PCT Filed: Apr. 15, 2010
(86) PCT No.: PCT/EP2010/002310

§ 371 Date: Sep. 8, 2011

(30) Foreign Application Priority Data
Apr. 17, 2009 (IT) MI2009A000632

(51) Int. Cl. E05C 1/10; E06B 3/00

(52) U.S. Cl. 49/503; 292/175

(57) ABSTRACT

A snap-acting locking device, particularly for lids, doors and the like, has a slider adapted to be associated with a movable member, such as a lid, a door or the like, and to engage by snap-action a locking member provided on a body which the movable member that constitutes its lid, door or the like is articulated. The slider is a single body constituted by an actuation pushbutton provided with a stem, provided with a locking means, and by an elastic member, which is jointly connected to a free end of the stem; the locking means detachably engages the locking member provided in the body.

The present invention relates to a snap-acting locking device, particularly for lids, doors and the like.

Many systems for snap-acting locking, by means of pushbuttons or levers which act by means of an elastic member to close lids, doors and the like and allow their quick opening, are known.

Conventional systems can be constituted by simple pushbuttons that act in contrast with a spring to actuate the locking means.

In other cases, the buttons themselves include the locking means or part thereof and the elastic means also can be obtained by means of blades or other elastically deformable parts that can be provided monolithically.

In the provision of pushbutton locking systems, the need is always felt to reduce production costs while attempting however to maintain good functionality and reliability of the system.

However, these needs are incompatible, and a simple mechanism is normally also a scarcely efficient and easily degradable device.

The aim of the present invention is to provide a snap-acting locking device that is at once constructively simple and extremely reliable and very durable.

An object of the invention is to provide a device that can be assembled with a single operation and in an extremely simple and quick manner.

Another object of the present invention is to provide a structure which, by virtue of its particular constructive characteristics, is capable of giving the greatest assurances of reliability and safety in use.

Another object of the present invention is to provide a structure that can be provided easily by using commonly commercially available elements and materials and is also competitive from a purely economic standpoint.

This aim and these and other objects that will become better apparent hereinafter are achieved by a snap-acting locking device, particularly for lids, doors and the like, characterized in that it comprises a slider adapted to be associated with a movable member, such as a lid, a door or the like, and to engage by snap action a locking member provided on a body on which the movable member that constitutes its lid, door or the like is articulated; said slider is a single body constituted by an actuation pushbutton provided with a stem, provided with a locking means, and by an elastic member, which is jointly connected to a free end of said stem; said locking means detachably engage said locking member provided in said body.

Further characteristics and advantages will become better apparent from the description of preferred but not exclusive embodiments of the invention, illustrated by way of non-limiting example in the accompanying drawings, wherein:

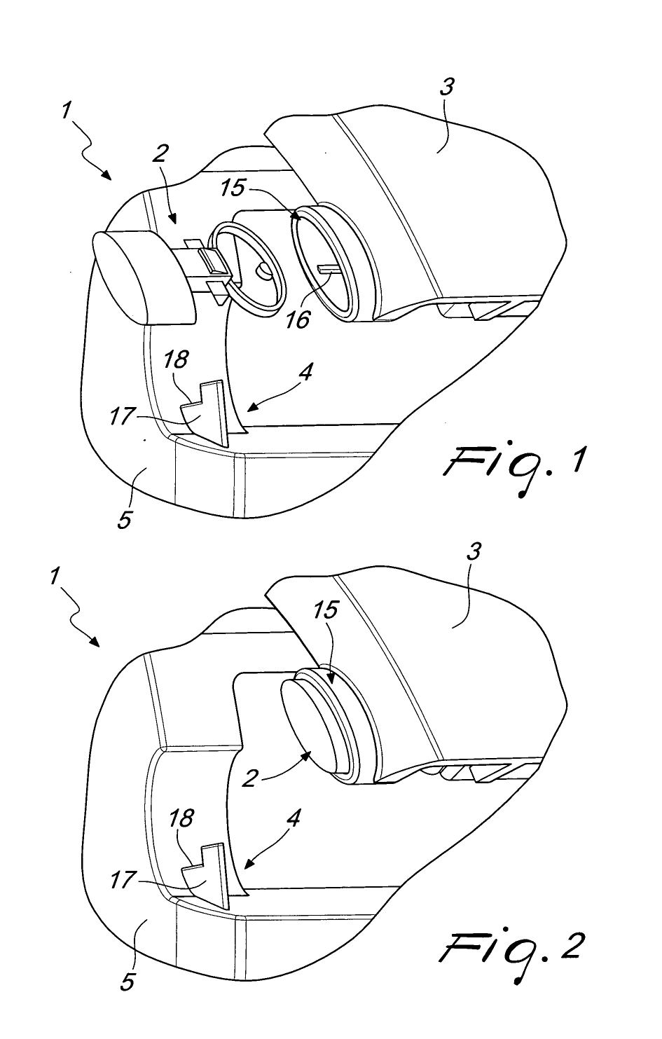

FIG. 1 is a partially exploded perspective view of an end of a door or tilting lid provided with the locking device according to the present invention;

FIG. 2 is a perspective view of the end of the door of the preceding figure with the device in the assembled condition;

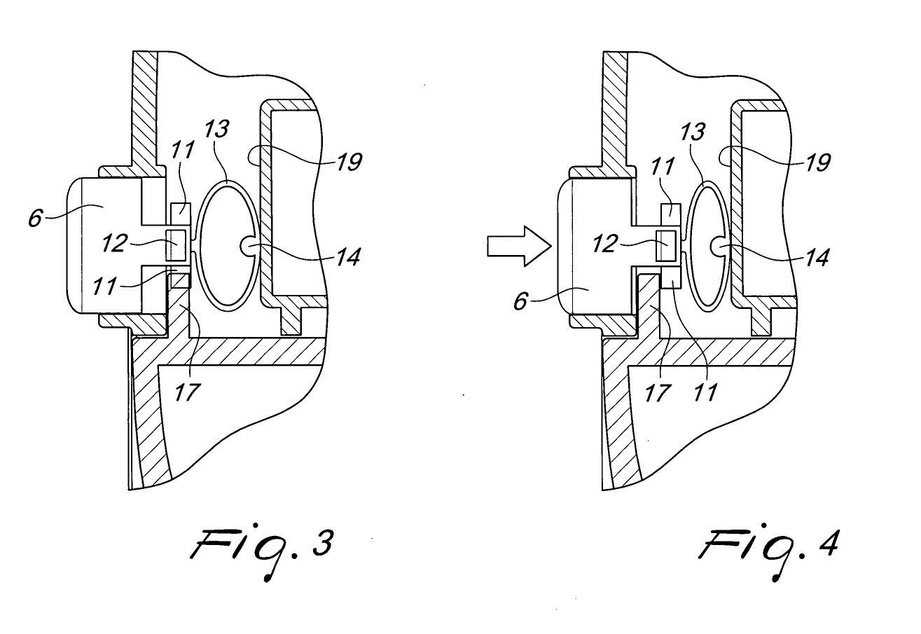

FIG. 3 is a sectional front view of the device in the locking position;

FIG. 4 is a view, similar to the preceding one, showing the device in the release position;

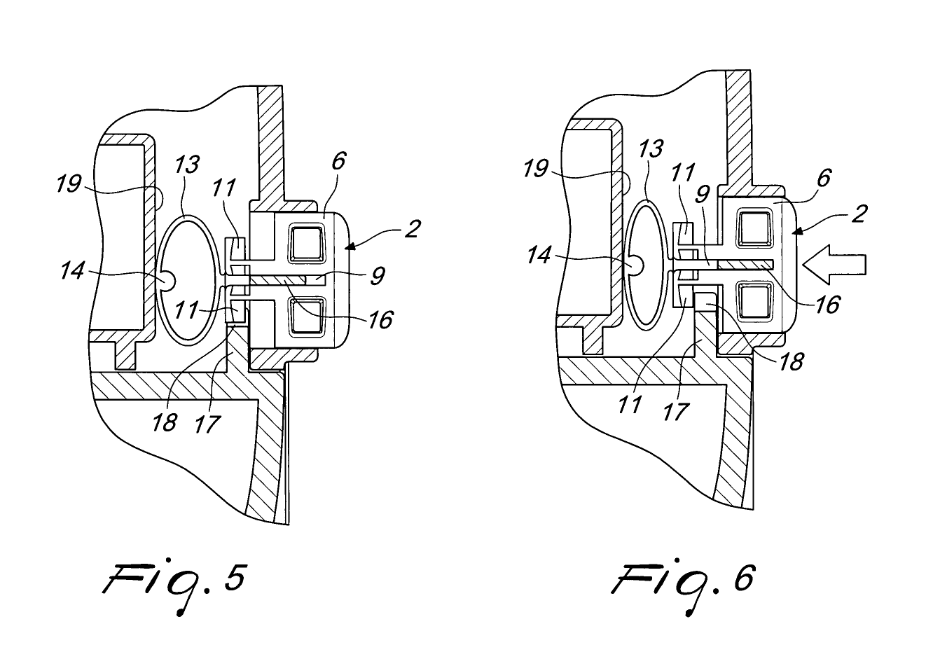

FIG. 5 is a sectional rear view of the device in the locking position;

FIG. 6 is a view, similar to the preceding one, showing the device in the release position;

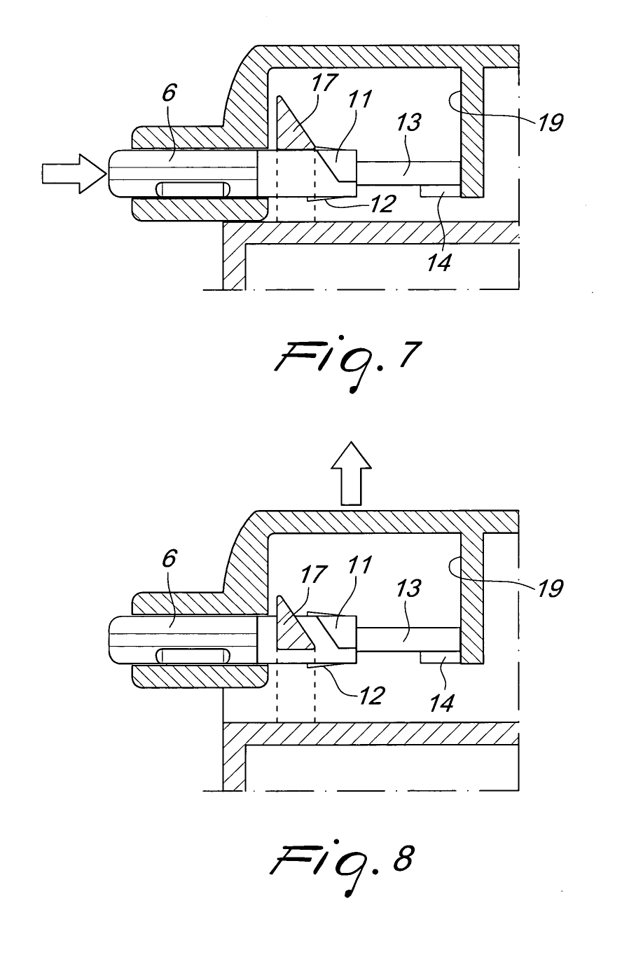

FIG. 7 is a sectional bottom view of the device shortly before release;

FIG. 8 is a view, similar to the preceding one, showing the device in the release step;

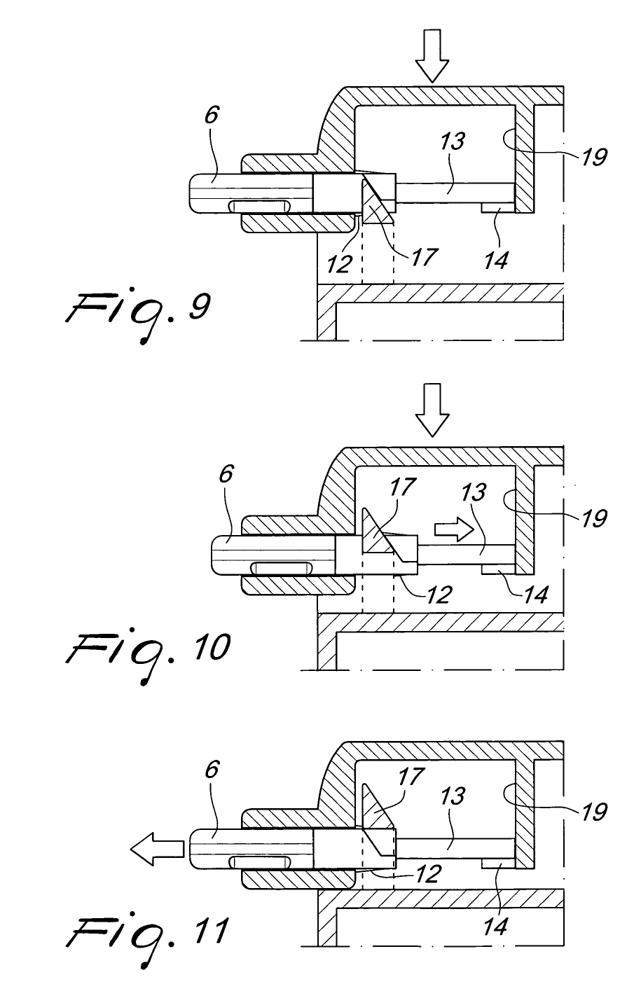

FIGS. 9-11 are sectional bottom views showing the closing steps of the door with which the device is associated and of its automatic locking;

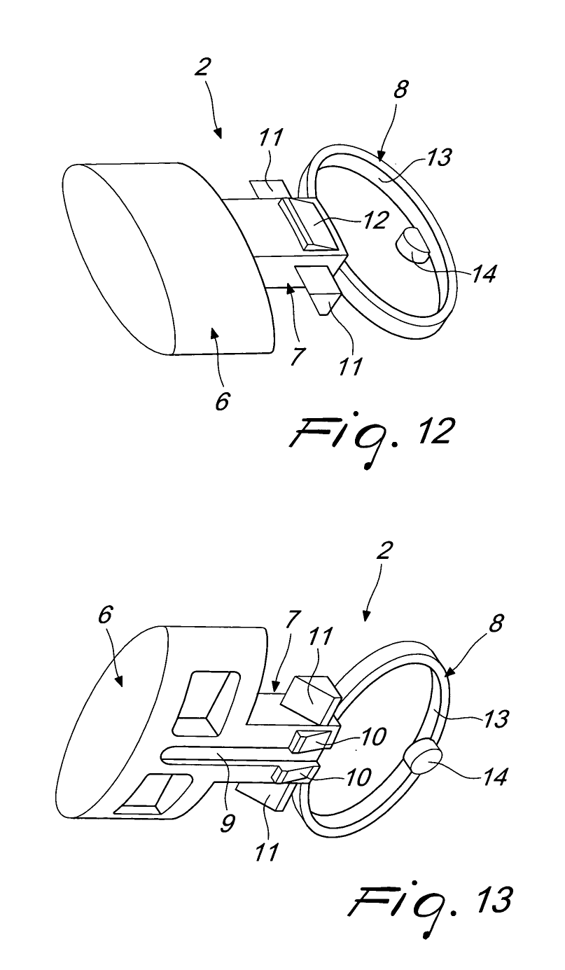

FIG. 12 is a perspective view of the front side of the slider;

FIG. 13 is a perspective view of the rear side of the slider.

With reference to the cited figures, the device according to the invention, generally designated by the reference numeral 1, comprises a slider 2 adapted to be associated with a movable member 3, such as a lid, a door of the like, and to engage a locking member 4 provided on a body 5 on which the movable member that constitutes its lid, door or the like is articulated.

The slider 2 is a single body constituted by an actuation pushbutton 6 provided with a stem 7, provided with a locking means, and an elastic member 8.

The pushbutton 6 includes, on its rear side, a longitudinal slot that runs substantially along the entire stem 7.

The stem 7 has a pair of inclined planes 10, on its rear side, and a pair of locking teeth 11 arranged laterally.

A retention tooth 12 is provided on the front side of the stem 7.

The elastic member 8 is constituted by a ring 13 provided on the free end of the stem 7.

A block 14 is provided on the inner side of the ring in a position that is diametrically opposite with respect to the free end of the stem 7.

The slider 2 enters a seat 15, which is provided in the movable member 3 and has an opening cross-section that is shaped in such a manner as to substantially correspond to the cross-section of the pushbutton 6, so that the slider can side in a linear fashion in the seat 15.

For this purpose, the seat 15 has a rib 16, which can slide in the longitudinal slot 9 that runs along the entire stem 7 of the slider.

The locking member 4 of the body 5 is substantially constituted by a wing 17, which is arranged transversely with respect to the sliding direction of the slider 2 and is adapted to constitute an engagement means for the locking means of the slider.

The wing 17 has a recess 18 in which one of the locking teeth 11 is accommodated when the device is in the closed position.

In this locking position, the elastic member acts in contrast with an abutment surface 19, which is jointly connected to the movable member 3 with which the slider is associated.

The slider is kept in its seat by teeth 10 and 12 and of the retention tooth 12 which locks the slider by abutting against the internal edge of the seat 15, as an effect of the thrust provided by the elastic member 8 constituted by the ring 13.

The thrust of the elastic member and the presence of the retention tooth 12 in abutment against the internal edge of the seat 15 keep the slider 2 in the locking position, i.e., with a locking tooth 11 at the recess 18 of the wing 17.

In order to release the device it is sufficient to press the pushbutton 6, overcoming the contrast force of the elastic member 8, to move the slider so as to free the locking tooth 11 and allow the opening of the movable body 3.

During closure, the inclined surface of the locking tooth 11 slides on an inclined surface of the wing 17, making the slider 2 slide in the seat 15, in contrast with the force of the elastic member 8, which returns the slider to the locking position once the locking tooth 11 has moved beyond the wing 17.

The assembly of the device is as simple as its operation.

Once the slider has been produced monolithically, for example by injection molding, without any further processing, it is simply inserted in the seat 15 of the movable member 3.

The mating of the rib 16 of the seat 15 with the longitudinal slot 9 of the slider acts as a guide in the operating movement of the slider and as an abutment, during assembly, to allow to univocally insert the slider in the seat without the possibility to reverse its position or direction of insertion.

It should be noted in fact that the longitudinal slot 9 does not run along the entire pushbutton 6 and it is therefore impossible to insert the slider in the seat 15 from the side of the pushbutton, and it is likewise impossible to insert it turned through 180° with respect to its central axis because the rib 16 would prevent it.

Of course, the positions of the slider 2, of the seat 15 and of the locking member 4 can be reversed, inserting the slider in a seat provided in the body 5 and providing the locking member in the movable member 3.

In practice it has been found that the invention achieves the intended aim and objects, a locking device having been provided which is constructively simple and at the same time extremely effective both functionally and as regards reliability and durability.

The annular structure of the elastic member in fact allows a long operating life of the elastic member, without losing effectiveness in the contrast action.

This application claims the priority of Italian Patent Application No. MI2009A000632, filed Apr. 17, 2009, the subject matter of which is incorporated herein by reference.

1-7. (canceled)

8. A snap-acting locking device particularly for lids, doors and other closure members, comprising a slider adapted to be associated with a movable closure member and to engage by snap action a locking member provided in or on a body to which said movable closure member is articulated, said slider being a single body constituted by an actuation pushbutton provided with a stem, provided with a locking means, and by an elastic member jointly connected to a free end of said stem, said locking means detachably engaging said locking member provided in or on said body, said slider including a longitudinal slot which runs partially within said pushbutton and substantially along all of said stem.

9. The device according to claim 8 wherein said elastic member comprises a ring provided on said free end of said stem.

10. The device according to claim 8, wherein said stem has a pair of inclined planes and a pair of laterally arranged locking teeth.

11. The device according to claim 8, wherein said stem has a retention tooth.

12. A movable closure member incorporating the device according claim 8, wherein said slider enters a seat which is provided in said movable closure member and has an opening cross-section that is shaped so as to correspond substantially to the cross-section of said pushbutton so that said slider can slide in a linear fashion within said seat, said seat comprising a rib which can slide in said longitudinal slot that runs along all of said stein of said slider.

13. A body and a movable closure member incorporating the device according to claim 8, wherein said locking member is substantially constituted by a wing arranged transversely to a sliding direction of said slider and adapted to constitute an engagement means for said locking means.

14. A body and a movable closure member according to claim 13, wherein: said slider enters a seat provided in said movable closure member; said stem has a retention tooth; said wing has a recess in which said retention tooth is accommodated when said device is in a closed or locking position; in this locking or locking position, said elastic member acts in contrast with an abutment surface, which is jointly connected to said movable closure member with which said slider is associated; said slider is kept in said seat by the presence of said retention tooth, which locks said slider, abutting against an internal edge of said seat, as an effect of thrust produced by said elastic member.
